(19) United States
(12) Patent Application Publication
(10) Pub. No.: US 2024/0021872 A1
(43) Pub. Date: Jan. 18, 2024

(54) ELECTRODE FOR QUASI-SOLID LI-ION BATTERY

(71) Applicant: Arkema France, Colombes (FR)

(72) Inventors: Gregory SCHMIDT, Pierre-Benite Cedex (FR); Stephane BIZET, Serquigny (FR); Marie BICHON, Pierre-Benite Cedex (FR)

(21) Appl. No.: 18/038,730

(22) PCT Filed: Dec. 1, 2021
(86) PCT No.: PCT/FR2021/052162

§ 371 Date: May 25, 2023

(30) Foreign Application Priority Data
Dec. 1, 2020 (FR) FR2012476

(51) Int. Cl. H01M 10/0565; H01M 4/62; H01M 4/13; H01M 50/457; H01M 50/417; H01M 10/0585; H01M 50/609

(52) U.S. Cl. CPC H01M 10/0565; H01M 4/623; H01M 4/13; H01M 50/457; H01M 50/417; H01M 10/0585; H01M 50/609; H01M 2300/0085

(57) ABSTRACT

The invention concerns a cathode composition comprising an intrinsically incorporated catholyte. The invention also concerns a quasi-solid-state Li-ion battery comprising said cathode, an anode and a separator, and a method for manufacturing said Li-ion battery.

### FIELD OF THE INVENTION

The present invention relates generally to the field of electrical energy storage in rechargeable secondary batteries of Li-ion type. More specifically, the invention concerns a cathode composition comprising an intrinsically incorporated catholyte. The invention also concerns a quasi-solid-state Li-ion battery comprising said cathode, an anode and a separator, and a method for manufacturing said Li-ion battery.

### TECHNICAL BACKGROUND

An Li-ion battery includes at least one negative electrode or anode coupled to a copper current collector, a positive electrode or cathode coupled to an aluminium current collector, a separator, and an electrolyte. The electrolyte consists of a lithium salt, generally lithium hexafluorophosphate, mixed with a solvent which is a mixture of organic carbonates, which are selected so as to optimize the transportation and the dissociation of the ions. A high dielectric constant promotes the dissociation of the ions, and thus the number of ions available in a given volume, while a low viscosity benefits the ionic diffusion which plays an essential role, among other parameters, in the speeds of charge and discharge of the electrochemical system.

Rechargeable, or secondary, batteries are more advantageous than primary batteries (which are not rechargeable) because the associated chemical reactions taking place at the positive and negative electrodes of the battery are reversible. The electrodes of the secondary cells can be regenerated multiple times by application of an electrical charge. Many advanced electrode systems have been developed for storing the electrical charge. In parallel, much effort has been devoted to developing electrolytes capable of improving the capacities of electrochemical cells.

Lithium-ion batteries conventionally use liquid electrolytes composed of solvent(s), lithium salt(s) and additive(s). These electrolytes have good ion conductivity but are liable to leak or catch alight if the battery is damaged. These difficulties can be overcome by using solid-state or quasi-solid-state electrolytes.

A further advantage of the solid-state or quasi-solid-state electrolytes is that they allow lithium metal to be used at the negative electrode, preventing the formation of dendrites, which can cause short-circuits during cycling. The use of lithium metal enables a gain in energy density relative to negative electrodes of insertion or alloy type.

Nevertheless, solid-state or quasi-solid-state electrolytes are generally less conductive than liquid electrolytes, especially in the cathode and the anode. The solid-state or quasi-solid-state electrolyte incorporated in the cathode is termed the catholyte. A recurrent problem with all-solid-state or quasi-solid-state batteries is that of obtaining a catholyte which is compatible chemically and electrochemically with the cathode, while having sufficient conductivity, and a low resistivity at the interfaces with the cathode. To improve the interfaces between the cathode and the catholyte, it is often necessary to apply high pressures, or to coat the catholyte directly onto the cathode, which adds a step to the manufacturing process.

Document FR 3049114 describes an all-solid-state battery comprising a solid polymer electrolyte, a negative electrode comprising lithium metal or a lithium metal alloy, and a positive electrode comprising an ion-conducting polymer. The drawback with this battery is that the ion conductivity of the solid-state electrolyte incorporated in the cathode is low at ambient temperature, and the lithium-ion cell has to be heated to 80° C. to exhibit good electrochemical performance.

Poly(vinylidene fluoride) (PVDF) and its derivatives are of advantage as the principal constituent material of the binder used in the electrodes on account of their electrochemical stability, and of their high dielectric constant which promotes dissociation of the ions and hence conductivity. The crystallinity of P(VDF-co-HFP) copolymer (copolymer of vinylidene fluoride (VDF) and hexafluoropropylene (HFP)) is lower than that of PVDF. The advantage of these P(VDF-co-HFP) copolymers is that they produce greater swelling in the electrolyte solvents and so promote ion conductivity in a quasi-solid-state Li-ion battery cathode.

Document U.S. Pat. No. 9,997,803, referring to FIG. 2, describes a secondary battery cell 20 comprising a cathode 21, an anode 22, a separator 23 and an electrolyte 24. This electrolyte comprises a high molecular weight compound and an electrolyte solution prepared by dissolving an electrolyte salt in a solvent, and the electrolyte solution is kept in the high molecular weight compound in order to gel the electrolyte solution. Said high molecular weight compound comprises a first compound having a weight-average molecular weight of 550 000 or more, and a second compound having a weight-average molecular weight of 1000 or more but not exceeding 300 000. The role of the first high molecular weight compound is to improve adhesion between the electrolyte 24, the cathode 21 and the anode 22. The intended role of the second high molecular weight compound is to improve the permeability of the electrolyte 24 in the cathode 21 and the anode 22. A third high molecular weight compound may be incorporated in the electrolyte. Each of these compounds is selected from PVDF and P(VDF-co-HFP) copolymers. The copolymers are block copolymers, and the amount of HFP by mass in the copolymer ranges from 3% to 7.5%.

In this document an active cathode material and a binder (VDF-HFP copolymer) and, optionally, an electrical conductor are mixed to prepare a cathode mixture, and the cathode mixture is dispersed in a solvent such as 2-methylpyrrolidone to form a cathode mixture slurry. Following application of the cathode mixture slurry to one or both sides of the current collector of cathode 21A and its drying, the layer of active material of cathode 21B is formed by compression moulding, to form the cathode 21. Applied to this cathode is an electrolyte solution obtained by mixing on one hand a solution formed from said high molecular weight compounds dissolved in a solvent such as dimethyl carbonate, and on the other hand a solvent comprising ethylene carbonate, propylene carbonate and LiPF₆. The layer 21B of active material of the cathode was left to stand at ambient temperature for 8 hours for volatilization of the dimethyl carbonate, leading to formation of the electrolyte 24.

But this preparation method remains laborious, adding as it does a step of coating of the electrolyte solution and a step of evaporating the dimethyl carbonate, so extending the time taken to produce the electrolyte and entailing extra manufacturing costs.

There is still a need to develop new cathode compositions comprising a catholyte, which feature a good trade-off between ion conductivity within the cathode at ambient temperature and low resistivity at the interfaces with the solid-state or quasi-solid-state electrolyte, and which are amenable to simplified implementation, without involving prior conversion steps. Further, the amount of catholyte in the cathode must be minimized so as to maximize the energy density of the Li-ion cell.

The aim of the invention is thus to address at least one of the drawbacks of the prior art; specifically, to propose a cathode for a quasi-solid-state Li-ion battery comprising a catholyte infiltrated in the electrode material and enabling sufficient swelling of the polymeric binder incorporated in said material without either loss of cohesion within the cathode or loss of adhesion to the current collector. Sufficient swelling means that the ambient-temperature ion conductivity of the cathode containing the catholyte is such that the capacity delivered on C/10 discharge is not less than 80% of the theoretical reversible capacity.

The invention also concerns a rechargeable secondary Li-ion battery comprising such a cathode containing a catholyte, an anode, and a separator.

Lastly, the invention concerns a method for producing an Li-ion battery comprising said cathode containing a catholyte, which is compatible with the customary industrial processes.

### SUMMARY OF THE INVENTION

The technical solution proposed by the present invention is a cathode comprising a catholyte mixed intrinsically with the electrode material.

In a first aspect, the invention concerns a cathode for a lithium-ion battery, comprising an active electrode material, a conductive additive, an inorganic oxide, a polymeric binder and a catholyte.

Characteristically, said binder is a mixture of two fluoropolymers: a fluoropolymer A which comprises at least one copolymer of vinylidene fluoride (VDF) and hexafluoropropylene (HFP) having an HFP content of not less than 3% by weight, and a fluoropolymer B which comprises a VDF homopolymer and/or at least one VDF-HFP copolymer, said fluoropolymer B having an HFP content by mass at least 3% by weight less than the HFP content by mass of the polymer A.

The catholyte comprises at least one solvent and at least one lithium salt.

In another aspect, the invention provides a rechargeable secondary Li-ion battery comprising a cathode, an anode and a separator, in which said cathode is as described above.

Lastly, the invention concerns a method for producing an Li-ion battery comprising said cathode.

The present invention makes it possible to overcome the drawbacks of the prior art. It is characterized by good ambient-temperature conductivity of the catholyte within the cathode. The cohesion and adhesion of the cathode and its flexibility are maintained with the catholyte.

Manufacture of the battery described by this invention does not necessitate further steps relative to the conventional manufacturing method used in the production of Li-ion cells: no catholyte coating step; no intense heat treatment step, of sintering for example, as required in the case of oxide-based solid-state electrolytes, with temperatures of more than 500° C.; no step of compression moulding at very high pressure; and nor does it necessitate monitoring the humidity or the atmosphere relative to the current methods.

The advantage of this technology is that it offers a better guarantee of safety relative to the liquid electrolytes: no leakage of electrolyte, and reduced flammability owing to the gelling of the catholyte.

### BRIEF DESCRIPTION OF THE FIGURES

FIG. 1 is a diagram representing the impedance spectra of cathodes in symmetrical batteries.

FIG. 2 is a diagram representing the capacity performance of a cathode according to the invention and of a cathode according to a comparative example, at a discharge current of 1 C.

### DESCRIPTION OF EMBODIMENTS OF THE INVENTION

The invention is now described in greater detail and in a non-limiting way in the description which follows.

In a first aspect, the invention concerns a cathode for a lithium-ion battery, comprising an active electrode material, a conductive additive, an inorganic oxide, a polymeric binder and a catholyte, wherein:
said binder is a mixture of two fluoropolymers: a fluoropolymer A which comprises at least one copolymer of vinylidene fluoride (VDF) and hexafluoropropylene (HFP) having an HFP content of not less than 3% by weight, and a fluoropolymer B which comprises a VDF homopolymer and/or at least one VDF-HFP copolymer, said fluoropolymer B having an HFP content by mass at least 3% by weight less than the HFP content by mass of the polymer A, and
said catholyte comprises at least one solvent and at least one lithium salt.

According to various embodiments, said cathode comprises the features below, in combination where appropriate. The contents indicated are expressed by weight, unless otherwise indicated.

Said active electrode material is selected from the compounds of the type xLi₂MnO₃·(1−x)LiMO₂ with 0≤x≤1, of the LiMPO₄ type, of the Li₂MPO₃F type, of the Li₂MSiO₄ type where M is Co, Ni, Mn, Fe or a combination of these, of the LiMn₂O₄ type or of the S₈ type.

Said conductive additive is selected from carbon blacks, graphites, natural or synthetic, carbon fibres, carbon nanotubes, metallic fibres and powders, or mixtures thereof.

Said inorganic oxide is selected from silicon oxides, titanium dioxide, aluminium oxides, zirconium oxide, zeolites or mixtures thereof.

Polymeric Binder

The fluoropolymer A comprises at least one VDF-HFP copolymer having an HFP content of not less than 3% by weight, preferably not less than 8%, advantageously not less than 13%. Said VDF-HFP copolymer has an HFP content of not more than 55%, preferably than 50%.

This very low-crystallinity copolymer swells readily in electrolyte solvents such as carbonates, nitriles and glymes, thus allowing the binder to be given a good ion conductivity. The swelling may be quantified by the increase in mass of the binder with electrolyte. The increase in mass of this copolymer is advantageously at least not less than 5% by weight.

According to one embodiment, the fluoropolymer A consists of a single VDF-HFP copolymer having an HFP content of not less than 3%. According to one embodiment, the HFP content of this VDF-HFP copolymer is between 13% and 55%, endpoints included, preferably between 15% and 50%, endpoints included.

According to one embodiment, the fluoropolymer A consists of a mixture of two or more VDF-HFP copolymers, the HFP content of each copolymer being not less than 3%. According to one embodiment, each of the copolymers has an HFP content of between 13% and 55%, endpoints included, preferably between 15% and 50%, endpoints included.

The fluoropolymer B comprises at least one VDF-HFP copolymer having an HFP content by mass at least 3% less than the HFP content by mass of the polymer A. This allows the cathode to be given sufficient mechanical strength after swelling. Sufficient mechanical strength means that the adhesion of the cathode to the current collector is maintained after swelling, as is the cohesion of the particles of active substance.

According to one embodiment, the fluoropolymer B consists of a single VDF-HFP copolymer. According to one embodiment, the HFP content of this VDF-HFP copolymer is between 1% and 5%, endpoints included. According to one embodiment, the HFP content of this VDF-HFP copolymer is between 1% and 10%, endpoints included.

According to one embodiment, the fluoropolymer B is a mixture of PVDF homopolymer with a VDF-HFP copolymer or else a mixture of two or more VDF-HFP copolymers.

According to one embodiment, the HFP content of the mixture of polymers A and B is more than 7% by weight.

According to one embodiment, the mixture of fluoropolymers A and B has a melting temperature of more than 150° C.

The molar composition of the units in the fluoropolymers may be determined by various means such as infrared spectroscopy or Raman spectroscopy. Conventional methods of elemental analysis of carbon, fluorine and chlorine or bromine or iodine elements, such as X-ray fluorescence spectroscopy, make it possible to calculate unambiguously the mass composition of the polymers, from which the molar composition is deduced.

Use may also be made of multinuclear NMR techniques, notably proton (1H) and fluorine (19F) NMR techniques, by analysis of a solution of the polymer in a suitable deuterated solvent. The NMR spectrum is recorded on an FT-NMR spectrometer equipped with a multinuclear probe. The specific signals given by the various monomers in the spectra produced according to one or another nucleus are then identified.

According to one embodiment, at least one of the fluoropolymers A and B comprises units carrying at least one of the following functionalities: carboxylic acid, carboxylic anhydride, carboxylic ester, epoxy group (such as glycidyl), amide, alcohol, carbonyl, mercapto, sulfide, oxazoline and phenol.

Said functionality is introduced onto the fluoropolymer by a chemical reaction which can be grafting or a copolymerization of the fluoropolymer with a compound carrying at least one of said functionalities, using techniques known to a person skilled in the art.

According to one embodiment, said functionality is a terminal group situated at the end of the fluoropolymer chain.

According to one embodiment, the monomer carrying a functional group is inserted in the fluoropolymer chain.

According to one embodiment, the carboxylic acid functionality is a hydrophilic group of (meth)acrylic acid type selected from acrylic acid, methacrylic acid, hydroxyethyl (meth)acrylate, hydroxypropyl (meth)acrylate and hydroxyethylhexyl (meth)acrylate.

When the fluoropolymer A or B is functionalized, the functional group content by mass is at least 0.01%, and not more than 5% based on the weight of the fluoropolymers.

According to one embodiment, the mass ratio of polymer A to polymer B is greater than 1.

Catholyte

The catholyte comprises at least one solvent and at least one lithium salt.

According to one embodiment, said solvent is selected from cyclic and acyclic alkyl carbonates, ethers, glymes, formates, esters, nitriles and lactones.

Mention may be made, among the ethers, of linear or cyclic ethers, such as dimethoxyethane (DME), methyl ethers of oligoethylene glycols of 2 to 100 oxyethylene units, dioxolane, dioxane, dibutyl ether, tetrahydrofuran, and mixtures thereof.

Mention may be made, among the esters, of phosphoric acid esters and sulfite esters.

Mention may be made, for example, of methyl formate, methyl acetate, methyl propionate, ethyl acetate, butyl acetate or mixtures thereof.

The glymes used are of general formula R₁—O—R₂—O—R₃ in which R₁ and R₃ are linear alkyls of 1 to 5 carbons and R₂ is a linear or branched alkyl chain of 3 to 10 carbons.

Mention may in particular be made, among the lactones, of gamma-butyrolactone.

Mention may be made, among the nitriles, for example, of acetonitrile, pyruvonitrile, propionitrile, methoxypropionitrile, dimethylaminopropionitrile, butyronitrile, succinonitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile, and mixtures thereof.

Mention may be made, among the carbonates, for example, of cyclic carbonates such as, for example, propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylene carbonate (VC) (CAS: 872-36-6), fluoroethylene carbonate (FEC) (CAS: 114435-02-8), trifluoropropylene carbonate (CAS: 167951-80-6) or their mixtures.

According to one embodiment, said lithium salt is selected from LiPF₆ (lithium hexafluorophosphate), LiFSI (lithium bis(fluorosulfonyl)imide), LiTFSI (lithium bis(trifluoromethane)sulfonimide), LiTDI (lithium 2-trifluoromethyl-4,5-dicyanoimidazolate), LiPO₂F₂, LiB(C₂O₄)₂, LiF₂B(C₂O₄)₂, LiBF₄, LiNO₃, LiClO₄ and mixtures thereof.

According to one embodiment, the catholyte further comprises salts having a melting temperature of less than 100° C. such as ionic liquids, which form liquids consisting solely of cations and anions.

Examples of organic cations include in particular the following cations: ammonium, sulfonium, pyridinium, pyrrolidinium, imidazolium, imidazolinium, phosphonium, lithium, guanidinium, piperidinium, thiazolium, triazolium, oxazolium, pyrazolium, and mixtures thereof.

Examples of anions include in particular the imides, especially bis(trifluoromethanesulfonyl)imide (abbreviated NTf2-) or bis(fluorosulfonyl)imide; borates, especially tetrafluoroborate (abbreviated BF4-); phosphates, especially hexafluorophosphate (abbreviated PF6-); phosphinates and phosphonates, especially alkyl-phosphonates; amides, especially dicyanamide (abbreviated DCA-); aluminates, especially tetrachloroaluminate (AlCl4-), halides (such as the anions bromide, chloride and iodide), cyanates, acetates (CH3COO—), especially trifluoroacetate; sulfonates, especially methanesulfonate (CH3SO3-), trifluoromethanesulfonate; and sulfates, especially hydrogen sulfate.

According to one embodiment, the catholyte consists of a mixture of solvent and lithium salt and is devoid of polymeric binder.

According to one embodiment, the catholyte further comprises solid-state electrolytes such as lithium superionic conductors (LISICONs) and derivatives, thio-LISICONs, structures of Li₄SiO₄—Li₃PO₄ type, sodium superionic conductors (NASICONs) and derivatives, structures of Li_{1.3}Al_{0.3}Ti_{1.7}(PO₄)₃(LATP) type, garnet structures Li₇La₃Zr₂O₁₂ (LLZO) and derivatives, perovskite structures Li₃ₓLa_{2/3-2x□1/3-2x}TiO₃ (0<x<0.16) (LLTO), amorphous, crystalline or semicrystalline sulfides such as, for example, LSS, LTS, LXPS, LXPSO or LATS sulfides in which X is the element Si, Ge, Sn, As, Al or a combination of these elements, S is the element S or Si or a combination of these elements, and T is the element Sn, and LiPSX, LiBSX, LiSnSX or LiSiSX sulfides in which X is the element F, Cl, Br or I. According to one embodiment, the solid-state electrolyte in the catholyte may be a combination of said solid-state electrolytes.

According to one embodiment, the catholyte further comprises a conductive organic polymer such as polymers based on PEO, PAN, PMMA, PVA.

According to one embodiment, the catholyte has a salt concentration of 0.05 moles/litre to 5 moles/litre in the solvent.

According to one embodiment, said cathode has the following composition by mass:
52% to 95.5% of active material, preferably from 65% to 92%,
1% to 11% of conductive additive, preferably from 1.5% to 7.5%,
1% to 11% of polymeric binder, preferably from 1.5% to 7.5%,
0% to 2% of inorganic oxide, preferably from 0% to 1%,
2.5% to 28% of catholyte, preferably from 5% to 20%,
the sum of all these percentages being 100%.

According to one embodiment, the ratio by mass of catholyte to polymeric binder in the cathode is from 0.05 to 20, preferably from 0.1 to 10.

According to one embodiment, said cathode has a mass ratio of the conductive additive to the polymeric binder greater than 0.7. Indeed, It has been found that the contact resistance of the cathode increases when the content of the conductive additive decreases compared to the content of the polymeric binder.

The cathode described above is manufactured by a method comprising the following steps:
mixing an active electrode material, a conductive additive, an inorganic oxide and a polymeric binder in a solvent, to give an ink. The mixture may be prepared using a planetary mixer or a dispersing disc. A solution of polymeric binder in a solvent is prepared, having a solids content of between 2% and 20%.
   The inorganic oxide is then dispersed in this solution. The conductive additive is then dispersed in this solution. The active substance is then dispersed in this solution and the solids content of the ink is adjusted by addition of solvent, to reach a value of between 30% and 80%.
coating said ink onto a current collector support. This collector may be an aluminium foil, optionally coated with a layer of electron conductor and/or of polymer, with a thickness of between 5 μm and 30 μm. The ink may be applied to one or both faces of the current collector.
drying said ink to form a coating. Drying may be performed on a hotplate or in an oven at a temperature varying within a range of between 20° C. and 150° C., with or without a flow of air.
calendering the assembly formed by the coating and the collector so as to obtain a temperature of between 50° C. and 130° C.;
impregnating said coating with an electrolyte comprising at least one solvent and at least one lithium salt. The cathode is advantageously impregnated in the Li-ion cell at the time of filling and before the cell is sealed.

### Li-Ion Battery

In another aspect, the invention provides a rechargeable secondary Li-ion battery comprising a cathode, an anode and a separator, wherein said cathode is as described above.

According to one embodiment, the anode is a foil of lithium metal.

According to one embodiment, the anode comprises a material for insertion of the lithium, such as graphite, metal oxides, non-graphitizable carbon, pyrolytic carbon, coke, carbon fibres, activated carbon, an alloy material such as one based on the elements Si, Sn, Mg, B, As, Ga, In, Ge, Pb, Sb, Bi, Cd, Ag, Zn, Zr, or a mixture of said anode materials.

According to one embodiment, said separator is a “conventional” separator comprising one or more porous polypropylene and/or polyethylene layers, and optionally comprising a coating on one or both faces of the separator. Said coating comprises a polymeric binder and inorganic particles.

According to one embodiment, said separator is a gelled polymeric membrane comprising a fluoropolymer film and an electrolyte comprising at least one solvent and at least one lithium salt, said fluoro film comprising at least one layer, said layer consisting of a mixture of two fluoropolymers: a fluoropolymer A which comprises at least one copolymer of vinylidene fluoride (VDF) and hexafluoropropylene (HFP) having an HFP content of not less than 3% by weight, and a fluoropolymer B which comprises a VDF homopolymer and/or at least one VDF-HFP copolymer, said fluoropolymer B having an HFP content by mass at least 3% by weight less than the HFP content by mass of the polymer A.

According to one embodiment, said film consists of a single layer.

According to one embodiment, said mixture comprises:
i. a proportion by mass of polymer A not less than 10% and not more than 99%, preferably not less than 50% and not more than 95%, advantageously not less than 25% and not more than 95%, and
ii. a proportion by mass of polymer B not more than 90% and more than 1%, preferably less than 50% and more than 5%.

According to one embodiment, said monolayer fluoropolymer film has a thickness of 1 to 1000 μm, preferably of 1 μm to 500 μm, and more preferably still between 5 μm and 100 μm.

According to one embodiment, when the film is a monolayer film, said fluoropolymer film may be manufactured by a solvent-mediated process. Polymers A and B are dissolved in a known solvent for polyvinylidene fluoride or its copolymers. Non-exhaustive examples of the solvent include N-methyl-2-pyrrolidone, dimethyl sulfoxide, dimethylformamide, methyl ethyl ketone and acetone. The film is obtained after the solution is applied to a flat substrate and the solvent evaporated.

According to one embodiment, said fluoropolymer film is a monolayer film in which at least one of the layers is composed of a mixture of polymers A and B according to the invention.

The overall thickness of the multilayer film is between 2 μm and 1000 μm, with the thickness of the fluoropolymer layer according to the invention being between 1 μm and 999 μm.

The additional layer or layers are selected from the following polymeric compositions:
a composition consisting of a fluoropolymer selected from vinylidene fluoride homopolymers and VDF-HFP copolymers containing preferably at least 90% by mass of VDF;
a composition consisting of a mixture of fluoropolymer selected from vinylidene fluoride homopolymers and VDF-HFP copolymers containing preferably at least 85% by mass of VDF, with a methyl methacrylate (MMA) homopolymer and the copolymers containing at least 50% by mass of MMA and at least one other monomer copolymerizable with MMA. Examples of a comonomer copolymerizable with MMA include alkyl (meth)acrylates, acrylonitrile, butadiene, styrene and isoprene. The MMA polymer (homopolymer or copolymer) advantageously comprises by mass from 0 to 20% and preferably 5 to 15% of a C1-C8 alkyl (meth)acrylate, which is preferably methyl acrylate and/or ethyl acrylate. The MMA polymer (homopolymer or copolymer) may be functionalized, meaning that it contains, for example, acid, acyl chloride, alcohol and/or anhydride functions. These functions may be introduced by grafting or by copolymerization. The functionality advantageously is in particular the acid function provided by the acrylic acid comonomer. A monomer may also be used that has two vicinal acrylic acid functions able to undergo dehydration to form an anhydride. The proportion of functionality may be from 0 to 15% by mass of the MMA polymer, for example from 0 to 10% by mass.

According to one embodiment, said fluoropolymer film is manufactured by a melt-state polymer conversion process such as flat film extrusion, blown film extrusion, calendering or compression moulding.

According to one embodiment, the membrane forming the separator further comprises inorganic fillers such as silicon oxides, titanium dioxide, aluminium oxides, zirconium oxide, zeolites or a mixture thereof.

According to one embodiment, the membrane further comprises solid-state electrolytes such as lithium superionic conductors (LISICONs) and derivatives, thio-LISICONs, structures of Li₄SiO₄—Li₃PO₄ type, sodium superionic conductors (NASICONs) and derivatives, structures of Li_{1.3}Al_{0.3}Ti_{1.7}(PO₄)₃ (LATP) type, garnet structures Li₇La₃Zr₂O₁₂(LLZO) and derivatives, perovskite structures Li₃ₓLa_{2/3-2x□1/3-2x}TiO₃ (0<x<0.16) (LLTO), amorphous, crystalline or semicrystalline sulfides such as, for example, LSS, LTS, LXPS, LXPSO or LATS sulfides in which X is the element Si, Ge, Sn, As, Al or a combination of these elements, S is the element S or Si or a combination of these elements, and T is the element Sn, and LiPSX, LiBSX, LiSnSX or LiSiSX sulfides in which X is the element F, Cl, Br or I. According to one embodiment, the solid-state electrolyte in the membrane may be a combination of said solid-state electrolytes.

According to one embodiment, said solvent is selected from cyclic and acyclic alkyl carbonates, ethers, glymes, formates, esters, nitriles and lactones.

Mention may be made, among the ethers, of linear or cyclic ethers, such as dimethoxyethane (DME), methyl ethers of oligoethylene glycols of 2 to 100 oxyethylene units, dioxolane, dioxane, dibutyl ether, tetrahydrofuran, and mixtures thereof.

Mention may be made, among the esters, of phosphoric acid esters and sulfite esters.

Mention may be made, for example, of methyl formate, methyl acetate, methyl propionate, ethyl acetate, butyl acetate or mixtures thereof.

The glymes used are of general formula R₁—O—R₂—O—R₃ in which R₁ and R₃ are linear alkyls of 1 to 5 carbons and R₂ is a linear or branched alkyl chain of 3 to 10 carbons.

Mention may in particular be made, among the lactones, of gamma-butyrolactone.

Mention may be made, among the nitriles, for example, of acetonitrile, pyruvonitrile, propionitrile, methoxypropionitrile, dimethylaminopropionitrile, butyronitrile, succinonitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile, and mixtures thereof.

Mention may be made, among the carbonates, for example, of cyclic carbonates, such as, for example, ethylene carbonate (EC) (CAS: 96-49-1), propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylene carbonate (VC) (CAS: 872-36-6), fluoroethylene carbonate (FEC) (CAS: 114435-02-8), trifluoropropylene carbonate (CAS: 167951-80-6) or their mixtures.

According to one embodiment, said lithium salt present in the separator is selected from LiPF₆ (lithium hexafluorophosphate), LiFSI (lithium bis(fluorosulfonyl)imide), LiTFSI (lithium bis(trifluoromethane)sulfonimide), LiTDI (lithium 2-trifluoromethyl-4,5-dicyanoimidazolate), LiPO₂F₂, LiB(C2O₄)₂, LiF₂B(C₂O₄)₂, LiBF₄, LiNO₃, LiClO₄ or a mixture thereof.

According to one embodiment, the electrolyte present in the separator comprises at least one additive as well as the solvent and the lithium salt. The additive may be selected from the group consisting of fluoroethylene carbonate (FEC), vinylene carbonate, 4-vinyl-1,3-dioxolan-2-one, pyridazine, vinylpyridazine, quinoline, vinylquinoline, butadiene, sebaconitrile, alkyl disulfides, fluorotoluene, 1,4-dimethoxytetrafluorotoluene, t-butylphenol, di-t-butylphenol, tris(pentafluorophenyl)borane, oximes, aliphatic epoxides, halogenated biphenyls, methacrylic acids, allyl ethyl carbonate, vinyl acetate, divinyl adipate, propane sultone, acrylonitrile, 2-vinylpyridine, maleic anhydride, methyl cinnamate, phosphonates, silane compounds containing a vinyl, and 2-cyanofuran.

The additive may also be selected from salts having a melting temperature of less than 100° C. such as ionic liquids, which form liquids consisting solely of cations and anions.

Examples of organic cations include in particular the following cations: ammonium, sulfonium, pyridinium, pyrrolidinium, imidazolium, imidazolinium, phosphonium, lithium, guanidinium, piperidinium, thiazolium, triazolium, oxazolium, pyrazolium, and mixtures thereof.

Examples of anions include in particular the imides, especially bis(trifluoromethanesulfonyl)imide and bis(fluorosulfonyl)imide; borates, especially tetrafluoroborate (abbreviated BF₄⁻); phosphates, especially hexafluorophosphate (abbreviated PF₆⁻); phosphinates and phosphonates, especially alkyl-phosphonates; amides, especially dicyanamide (abbreviated DCA⁻); aluminates, especially tetrachloroaluminate (AlCl₄⁻), halides (such as the anions bromide, chloride, iodide, etc.), cyanates, acetates (CH₃COO⁻) especially trifluoroacetate; sulfonates, especially methanesulfonate (CH₃SO₃⁻), trifluoromethanesulfonate; and sulfates, especially hydrogen sulfate.

According to one embodiment, said electrolyte in the separator has a salt concentration of 0.05 moles/litre to 5 moles/litre in the solvent.

According to one embodiment, the ratio of electrolyte to fluoropolymer in the separator is from 0.05 to 20, preferably from 0.1 to 10.

According to one embodiment, said film in the separator has an increase in mass at least not less than 5% by weight, preferably of from 10% to 1000%.

The separator in gelled polymeric membrane form is advantageously non-porous, meaning that the gas permeability of the separator is 0 ml/min, as detected by the gas permeability test (when the surface area of the separator is 10 cm², the difference in pressure of gas on either side is 1 atm, and the time is 10 minutes).

According to one embodiment, said separator contains a single gelled polymeric membrane. According to another embodiment, said separator consists of a multilayer film in which each layer has the composition of the film described above. In the separator the membrane is advantageously not supported by a support.

Lastly, the invention concerns a method for producing an Li-ion battery comprising said cathode.

The Li-ion cell is produced by assembly of the anode, the separator and the cathode.

According to one embodiment, a liquid electrolyte comprising at least one solvent and at least one lithium salt is introduced into the cell before the cell is sealed, to form the catholyte by swelling of the binder in the cathode.

The cell may be heated between 30° C. and 90° C., and preferably between 40° C. and 70° C. for 5 min to 24 h, and preferably for 30 min to 12 h to promote the swelling of the binder in the cathode impregnated with the catholyte, and of the polymeric gel in the separator (where appropriate). The Li-ion cell may also be subjected to increased pressure of 0.01 MPa to 3 MPa to promote the impregnation of the catholyte in the cathode.

According to one embodiment, the cathode containing the catholyte is assembled with a separator and an anode; the separator may be a solid-state or quasi-solid-state electrolyte such as a polymer gel electrolyte.

### EXAMPLES

The following examples non-limitingly illustrate the scope of the invention.

Manufacture of a Cathode

Products:
Active substance (AS): NMC622
Carbon black (CB): Super C65
PVDF 1: Copolymer of vinylidene fluoride (VDF) and hexafluoropropylene (HFP) containing 25% by weight of HFP, characterized by a melt viscosity of 1000 Pa·s at 100 s⁻¹ and 230° C.
PVDF 2: Vinylidene fluoride homopolymer, characterized by a melt viscosity of 1000 Pa·s at 100 s⁻¹ and 230° C.
PVDF 3:—Vinylidene fluoride homopolymer, acid-functionalized with a functionality content of about 1% by mass, characterized by a viscosity of 547 cP at 5 s⁻¹ and 25° C. in an NMP solution at a solids content of 10%.

Catholyte: 0.75 M Lithium bis(fluorosulfonyl)imide (LiFSI) sold by Arkema in DME.

A number of quasi-solid-state cathodes are prepared by mixing the active substance, the carbon black electron conductor and the binder, which may be a mixture of PVDF in an N-methylpyrrolidone solvent. The ink is coated onto an aluminium current collector, which is then dried to evaporate the solvent. The electrode is then calendered to reduce the porosity.

The composition by mass of the various cathodes is summarized in Table 1:

TABLE 1

| | | | | | | Cath- | Ratio |
|---|---|---|---|---|---|---|---|
| | AS | CB | PVDF 1 | PVDF 2 | PVDF 3 | olyte | CB/ |
| | (%) | (%) | (%) | (%) | (%) | (%) | PVDF |
| Example 1 | 67.4 | 8.4 | 6.3 | 2.1 | — | 15.8 | 1 |
| Example 2 | 69.1 | 6.7 | 6.3 | — | 2.1 | 15.8 | 0.8 |
| Comparative | 95 | 2 | — | — | 3 | — | 0.67 |
| Example 1 | | | | | | | |
| Comparative | 90.5 | 1.9 | 1.9 | — | 1.0 | 4.7 | 0.66 |
| Example 2 | | | | | | | |
| Comparative | 75.7 | 4.3 | 5.2 | — | 1.7 | 13.1 | 0.62 |
| Example 3 | | | | | | | |

Measuring the Contact Resistance of Cathodes by Impedance Spectroscopy:

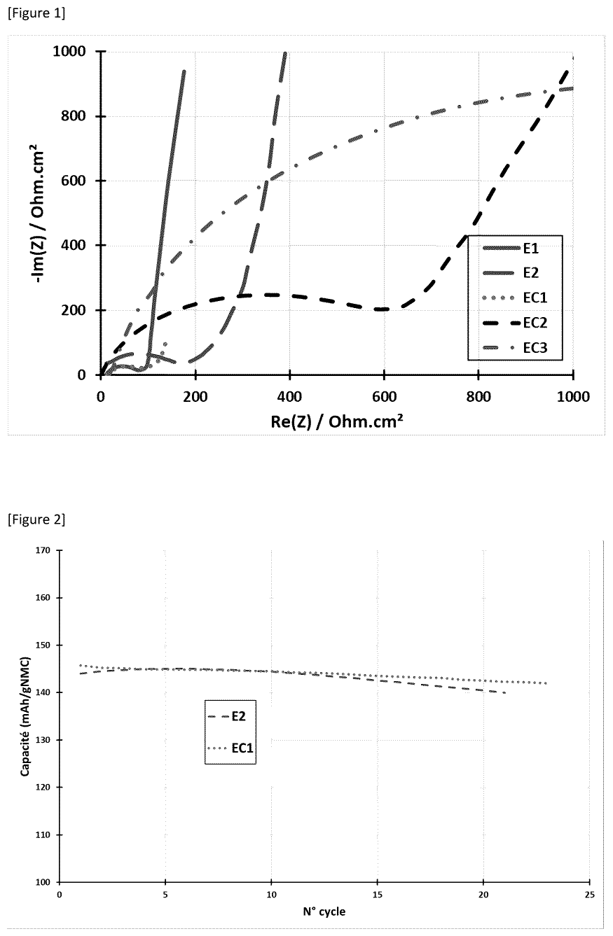

Impedance measurements are carried out on button cells containing two similar cathodes, separated by a triple-layer PP/PE/PP separator. FIG. 1, appended, presents the impedance spectra obtained with the cathodes of Table 1. The diameter of the semicircle is proportional to the contact resistance at the interface between the cathode and the aluminium current collector. Despite their high binder content, the cathodes of Examples 1 and 2 have a relatively low contact resistance close to that of Comparative Example 1. The contact resistance increases when the carbon black content decreases relative to the binder, as shown by the values CB/PVDF in table 1.

Evaluation of Cathode Performance at 1 C:

The cathode of Example 2 is assembled as a button cell against a lithium metal anode. The separator is a membrane consisting of PVDF 1 and PVDF 2. 20 μl of liquid electrolyte containing 0.75 M LiFSI in dimethoxyethane solvent are injected into the button cell before the cell has been sealed. The cell is then stoved at 45° C. for 2 h for the electrolyte to swell the polymer and form a gel in the separator and the catholyte.

The cathode of Comparative Example 1 is assembled as a button cell against a lithium metal anode.

The separator is a triple PP/PE/PP layer and the electrolyte contains 1 M LiPF₆ in EC/EMC (3:7, vol).

FIG. 2, appended, presents the capacity delivered by the cathodes E2 and CE1 at a discharge current of 1 C.

The quasi-solid-state cathode of Example 2, assembled with a polymer gel electrolyte, has a performance similar at 1 C to the cathode of Comparative Example 1, which operates with a liquid electrolyte.

1. A cathode for a lithium-ion battery, comprising an active electrode material, a conductive additive, an inorganic oxide, a polymeric binder and a catholyte, wherein:
said binder is a mixture of two fluoropolymers: a fluoropolymer A which comprises at least one copolymer of vinylidene fluoride (VDF) and hexafluoropropylene (HFP) having an HFP content of not less than 3% by weight, and a fluoropolymer B which comprises a VDF homopolymer and/or at least one VDF-HFP copolymer, said fluoropolymer B having an HFP content by mass at least 3% by weight less than the HFP content by mass of the polymer A, and
said catholyte comprises at least one solvent and at least one lithium salt.

2. The cathode according to claim 1, wherein the of at least one copolymer of fluoropolymer A has a HFP content of not less than 8% and not more than 55%.

3. The cathode according to claim 1, wherein the HFP content of the mixture of polymers A and B is more than 7% by weight.

4. The cathode according to claim 1, wherein the ratio by mass of polymer A to polymer B is more than 1.

5. The cathode according to claim 1, wherein said active material is selected from the group consisting of xLi₂MnO₃·(1−x)LiMO₂ with 0≤x≤1, LiMPO₄, Li₂MPO₃F, Li₂MSiO₄ where M is Co, Ni, Mn, Fe or a combination of these, LiMn₂O₄ and S₈.

6. The cathode according to claim 1, wherein said conductive additive is selected from the group consisting of carbon blacks, natural or synthetic graphites, carbon fibres, carbon nanotubes, metallic fibres and powders, conductive metal oxides, and mixtures thereof.

7. The cathode according to claim 1, wherein the solvent present in said catholyte is selected from the group consisting of cyclic alkyl carbonates, acyclic alkyl carbonates, ethers, glymes, formates, esters, nitriles and lactones.

8. The cathode according to claim 1, wherein the lithium salt present in said catholyte is selected from the group consisting of LiPF₆, LiFSI, LiTFSI, LiTDI, LiPO₂F₂, LiB(C₂O₄)₂, LiF₂B(C₂O₄)₂, LiBF₄, LiNO₃, and LiClO₄ and mixtures thereof.

9. The cathode according to claim 1, wherein the catholyte has a lithium salt concentration of 0.05 to 5 moles/litre in the solvent.

10. The cathode according to claim 1, wherein the ratio of catholyte to polymeric binder is from 0.05 to 20.

11. The cathode according to claim 1, wherein the ratio of the mass content of the conductive additive to the polymeric binder is greater than 0.7.

12. The cathode according to claim 1, said cathode having the following composition by mass:
52% to 95.5% of active material,
1% to 11% of conductive additive,
1% to 11% of polymeric binder,
0% to 2% of inorganic oxide,
2.5% to 28% of catholyte,
the sum of all these percentages being 100%.

13. A secondary Li-ion battery comprising an anode, a cathode and a separator, wherein the cathode has the composition according to claim 1.

14. The secondary Li-ion battery according to claim 13, wherein said separator comprises one or more porous layers of polypropylene and/or polyethylene, and optionally comprises a coating on one or both faces of the separator, said coating comprising a polymeric binder and inorganic particles.

15. The secondary Li-ion battery according to claim 13, wherein said separator is a gelled polymeric membrane comprising a fluoropolymer film and an electrolyte comprising at least one solvent and at least one lithium salt, said fluoropolymer film comprising at least one layer, said layer consisting of a mixture of two fluoropolymers: a fluoropolymer A which comprises at least one copolymer of vinylidene fluoride (VDF) and hexafluoropropylene (HFP) having an HFP content of not less than 3% by weight, and a fluoropolymer B which comprises a VDF homopolymer and/or at least one VDF-HFP copolymer, said fluoropolymer B having an HFP content by mass of at least 3% by weight less than the HFP content by mass of the polymer A.

16. The secondary Li-ion battery according to claim 15, wherein said solvent is selected from the group consisting of cyclic alkyl carbonates, acyclic alkyl carbonates, ethers, glymes, formates, esters, nitriles and lactones.

17. The secondary Li-ion battery according to claim 15, wherein said lithium salt is selected from the group consisting of LiPF₆, LiFSI, LiTFSI, LiTDI, LiPO₂F₂, LiB(C₂O₄)₂, LiF₂B(C₂O₄)₂, LiBF₄, LiNO₃ and LiClO₄.

18. A method for manufacturing an Li-ion battery according to claim 13, said method comprising the assembly of the anode, the separator and the cathode in a cell.

19. The method according to claim 18, said method comprising a step of introducing an electrolyte comprising at least one solvent and at least one lithium salt before sealing the cell.

20. The method according to claim 19, said method further comprising a step of heating the cell at between 30° C. and 90° C. for 5 min to 24 h.
